(19) United States
(12) Patent Application Publication
(10) Pub. No.: US 2006/0268146 A1
(43) Pub. Date: Nov. 30, 2006

(54) Autofocus systems and methods

(75) Inventor: Wei-I Lee, Taipei City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/136,416

(22) Filed: May 25, 2005

(51) Int. Cl. G03B 13/00

(52) U.S. Cl. 348/345

(57) ABSTRACT

An AF assistance apparatus comprises a lamp, a shading sheet and a control unit. The control unit, coupled to the lamp, turns on the lamp to emit light or signals through the shading sheet after receiving an enabling signal, and turns off the lamp after receiving a disabling signal.

### BACKGROUND

The invention relates to digital image acquisition, and more particularly, to systems and methods of autofocus.

A picture in focus is sharp, crisp, and clear, with the details highly visible and clearly delineated. Typically, digital cameras offer several different focus options, or autofocus. Autofocus provides relatively easy function for less-experienced users, who need only point the camera directly at subjects, with the target centered in the viewfinder. Normally, pressing the shutter button partially and holding it, activates automatic focus thereon. As long as the button is depressed partially, the autofocus remains locked at the original distance, allowing the camera to move to compose the photograph.

Conventional autofocus entails several limitations often associated with low-light settings. To overcome such limitations, some digital cameras are internally equipped with AF lamps. AF lamps generate light when the shutter button is partially depressed. The light may be infrared or white. Typically, the AF lamp is only bright enough to emit up to about 8 to 10 feet enough, facilitate improved autofocus operation. Some digital cameras, however, may not provide AF lamps therein.

### SUMMARY

Systems for AF (autofocus) are provided. An exemplary embodiment of an AF system comprises an AF assistance apparatus comprising a lamp, a first shading sheet and a control unit. The control unit, coupled to the lamp, turns on the lamp to emit light or signals through the first shading sheet after receiving an enabling signal, and turns off the lamp after receiving a disabling signal.

The system may further comprise a digital camera transmitting the enabling signal before performing the AF process, and the disabling signal after completing the AF process. The AF process may be implemented upon detection of a shutter button depressed partially.

The AF assistance apparatus may further comprise a first USB (Universal Serial Bus) connection device coupled to the control unit. The digital camera may further comprise a second USB connection device. The enabling and disabling signal may be transmitted and received via the first and second USB connection devices, preferably via the reserved ID pins of the first and second USB connection devices. The AF assistance apparatus may further comprise a mode controller, coupled to the control unit and determining whether the lamp is controlled by signals detected from the first USB connection device. The AF assistance apparatus may further comprise a second shading sheet and a switching device. The switching device switches the first and second shading sheets, enabling light or signals through the second shading sheet. The AF assistance apparatus may further comprise a brightness controller coupled to the control unit to adjust lamp brightness.

An exemplary embodiment of an AF system comprises an AF assistance apparatus and a digital camera. The AF assistance apparatus turns on a lamp therein to emit light or signals through a shading sheet therein after receiving an enabling signal, and turns off the lamp after receiving a disabling signal. The digital camera, coupled to the AF assistance apparatus, transmits the enabling signal before performing AF process, and transmits the disabling signal after completing the AF process. The enabling and disabling signals may be transmitted and received via a first USB (Universal Serial Bus) connection device in the AF assistance apparatus, and a second USB connection device in the digital camera. Preferably, the enabling and disabling signal are transmitted and received via the reserved ID pins of the first and second USB connection devices. The AF process may be performed after detecting a shutter button in the digital camera is partially depressed.

AF methods are further provided. An exemplary embodiment of an AF method performed by an AF assistance apparatus comprising a lamp and a shading sheet, and a digital camera, turns on the lamp to emit light or signals through the shading sheet after receiving an enabling signal from the digital camera, and turns off the lamp after receiving a disabling signal from the digital camera.

The enabling signal may be transmitted by the digital camera before performing an AF process, and the disabling signal may be transmitted by the digital camera after completing the AF process. The AF process may be performed after detecting a shutter button in the digital camera is partially depressed. The enabling and disabling signal may be received via a USB (Universal Serial Bus) connection device in the AF assistance apparatus. Preferably, the enabling and disabling signal may be received via the reserved ID pin of the USB (Universal Serial Bus) connection device in the AF assistance apparatus.

### BRIEF DESCRIPTION OF THE DRAWINGS

The invention will become more fully understood by referring to the following detailed description of embodiments with reference to the accompanying drawings, wherein:

FIG. 1 is a schematic diagram of an embodiment of an AF (autofocus) system;

FIG. 2 is a diagram of a hardware environment applicable to an embodiment of an AF assistance apparatus;

FIGS. 3a, 3b and 3c illustrate exemplary patterns formed on shading sheets;

FIG. 4 is a flowchart of an embodiment of a method for AF.

### DESCRIPTION

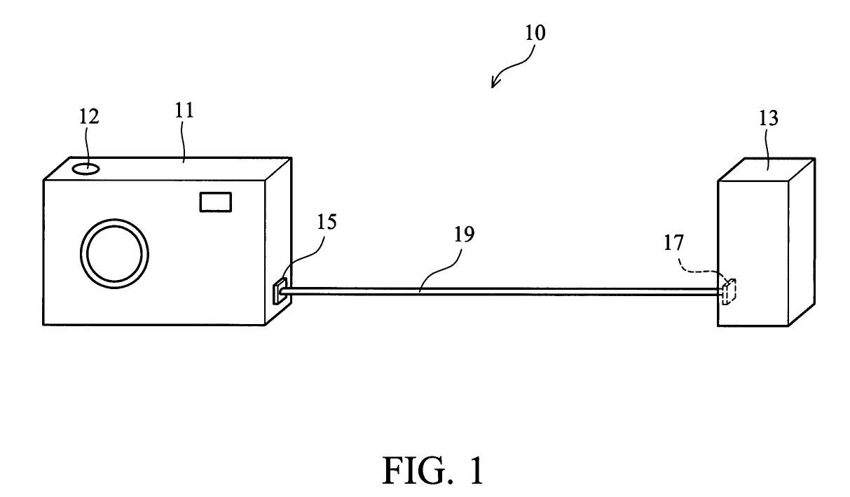

FIG. 1 is a diagram of an embodiment of an AF (autofocus) system 10, comprising a digital camera 11 and an AF assistance apparatus 13, connected via USB (Universal Serial Bus) connection devices 15 and 17, and USB cable 19. The digital camera 11 receives a signal from a shutter button 12 to initiate an autofocus operation. Subsequently, the digital camera 11 directs the AF assistance apparatus 13 to turn on after initiating an autofocus operation, and otherwise, to turn off after completing the entire autofocus operation. The AF assistance apparatus 13 provides light such as infrared, white lights, laser beams and the like, or signals such as sonar echoes and the like, to emit and facilitate an autofocus operation in dark shooting conditions. AF may operate by varying the motorized focus in the digital camera 11 to maximize the high frequency content of the central area of the picture using a combination of contrast detection and phase detection with reference to high luminance and strong contrast elements. The USB connection devices 15 and 17 respectively have five pins such as Vbus, D+, D−, GND and ID, with ID pins reserved in original USB specifications.

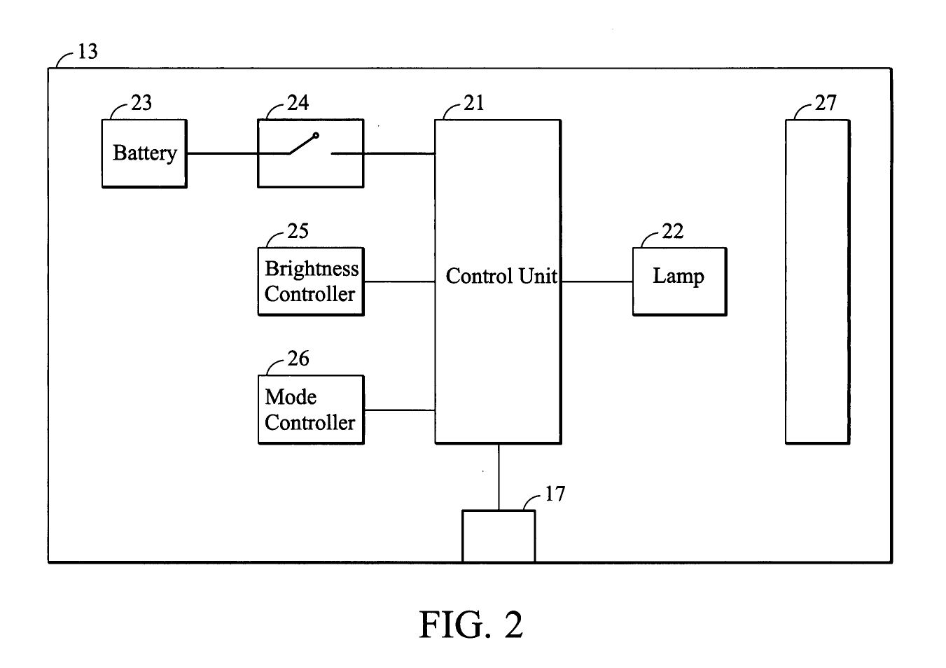

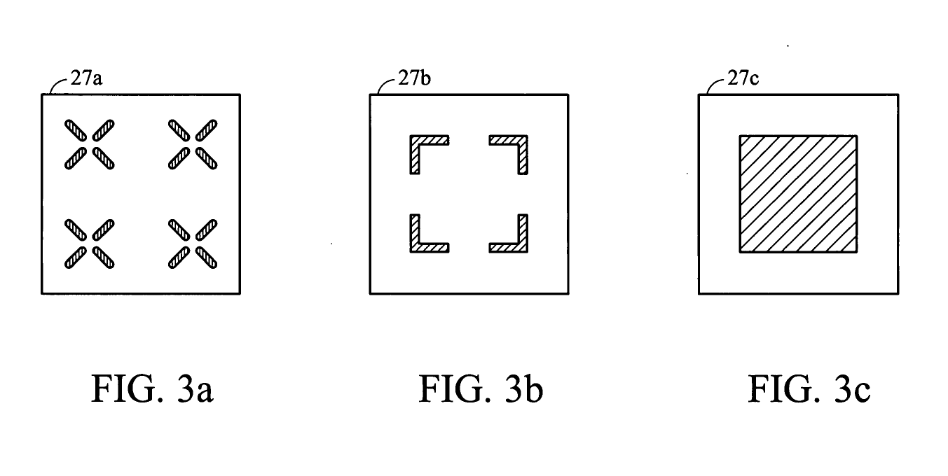

FIG. 2 is a diagram of a hardware environment applicable to an embodiment of an AF assistance apparatus, comprising a USB connection device 17, a control unit 21, a lamp 22, a battery 23, a power switching device 24, a brightness controller 25, a mode controller 26 and at least one shading sheet 27. When the power switching device 24 is turned on, the battery 23 powers the control unit 21, lamp 22, brightness controller 25, mode controller 26 and USB connecting device 17. The control unit 21 receives signals from the brightness controller 25 to adjust lamp brightness, and receives signals from the mode controller 26 to determine a control mode. The control mode determines whether the lamp 22 is controlled by signals detected from the USB connecting device 17, preferably via the reserved ID pin. The AF assistance apparatus 13 provides light or signals to emit a specific pattern through the shading sheet 27. There may be more than one shading sheet 27 switched by a mechanical device (not shown) or a sheet exchange controller (not shown) of the control unit 21 to switch shading sheets 27, enabling light or signals through another shading sheet. FIGS. 3a, 3b and 3c illustrate exemplary patterns respectively formed on shading sheets 27a, 27b and 27c.

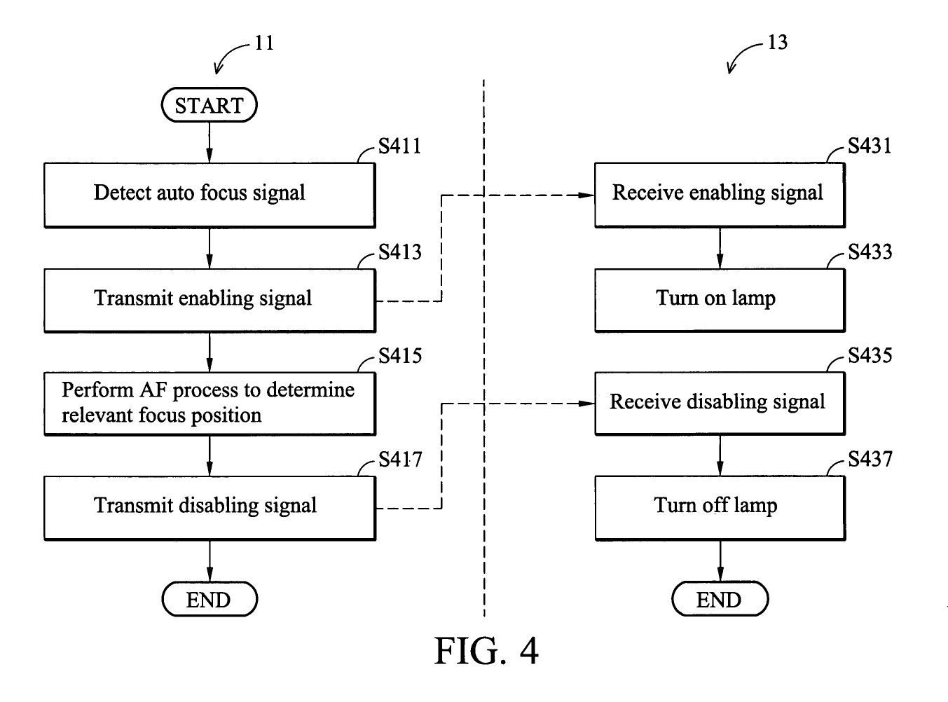

FIG. 4 is a flowchart of an embodiment of a method for AF, divided into three sections, a left section showing steps performed by the digital camera 11, and a right section showing steps performed by the AF assistance apparatus 13, separated by dashed lines for added clarity.

In step S411, an autofocus signals is detected by the digital camera 11. It may detect that a shutter button is partially depressed. In step S413, an enabling signal is transmitted to direct the AF assistance apparatus 13 to turn on the lamp 22. In step S431, the enabling signal is received by the AF assistance apparatus 13. In step S433, the lamp 22 is turned on. The enabling signal may be transmitted via USB connection devices 15 and 17, preferably, via the reserved ID pins of USB connection devices 15 and 17.

In step S415, AF process is performed by the digital camera 11. Numerous well-known AF processes can be employed to determine a relevant focus position. In step S417, a disabling signal is transmitted to direct the AF assistance apparatus 13 to turn off the lamp 22. In step S435, the disabling signal is received by the AF assistance apparatus 13. In step S437, the lamp 22 is turned off. The disabling signal may be transmitted via USB connection devices 15 and 17, preferably, via the reserved ID pins of USB connection devices 15 and 17.

Although the invention has been described in terms of preferred embodiment, it is not limited thereto. Those skilled in this technology can make various alterations and modifications without departing from the scope and spirit of the invention. Therefore, the scope of the invention shall be defined and protected by the following claims and their equivalents.

What is claimed is:

1. A system for autofocus (AF), comprising:
an AF assistance apparatus comprising:
a lamp;
a first shading sheet; and
a control unit coupled to the lamp, turning on the lamp to emit light or signals through the first shading sheet after receiving an enabling signal, and turning off the lamp after receiving a disabling signal.

2. The system of claim 1 further comprising a digital camera transmitting the enabling signal before performing an AF process, and transmitting the disabling signal after completing the AF process.

3. The system of claim 2 where the AF process is performed after detecting a shutter button in the digital camera is partially depressed.

4. The system of claim 1 wherein the AF assistance apparatus comprises a first USB (Universal Serial Bus) connection device coupled to the control unit, the digital camera comprises a second USB connection device, and the enabling and disabling signal are transmitted and received via the first and second USB connection devices.

5. The system of claim 4 wherein the enabling and disabling signal are transmitted and received via the reserved ID pins of the first and second USB connection devices.

6. The system of claim 4 wherein the AF assistance apparatus further comprises a mode controller coupled to the control unit and determining whether the lamp is controlled by signals detected from the first USB connection device.

7. The system of claim 1 wherein the AF assistance apparatus further comprises:
a second shading sheet; and
a switching device switching the first and second shading sheets, enabling emission of light or signals through the second shading sheet.

8. The system of claim 1 wherein the AF assistance apparatus further comprises a brightness controller coupled to the control unit for adjusting lamp brightness.

9. A system for autofocus (AF), comprising:
an AF assistance apparatus turning on a lamp therein to emit light or signals through a shading sheet therein after receiving an enabling signal, and turning off the lamp after receiving a disabling signal; and
a digital camera coupled to the AF assistance apparatus, transmitting the enabling signal before performing an AF process, and transmitting the disabling signal after completing the AF process.

10. The system of claim 9 wherein the enabling and disabling signal are transmitted and received via a first USB (Universal Serial Bus) connection device in the AF assistance apparatus, and a second USB connection device in the digital camera.

11. The system of claim 10 wherein the enabling and disabling signal are transmitted and received via the reserved ID pins of the first and second USB connection devices.

12. The system of claim 9 wherein the AF process is performed after detecting a shutter button in the digital camera is partially depressed.

13. A method for autofocus (AF), performed by an AF assistance apparatus comprising a lamp and a shading sheet, and a digital camera, comprising:
turning on the lamp to emit light or signals through the shading sheet after receiving an enabling signal from the digital camera; and
turning off the lamp after receiving a disabling signal from the digital camera.

14. The method of claim 13 wherein the enabling signal is transmitted by the digital camera before performing an AF process, and the disabling signal is transmitted by the digital camera after completing the AF process.

15. The method of claim 14 wherein the AF process is performed after detecting a shutter button in the digital camera is partially depressed.

16. The method of claim 13 wherein the enabling and disabling signal are received via a USB (Universal Serial Bus) connection device in the AF assistance apparatus.

17. The method of claim 16 wherein the enabling and disabling signal are received via the reserved ID pin of the USB (Universal Serial Bus) connection device in the AF assistance apparatus.
